(19) United States
(12) Patent Application Publication
(10) Pub. No.: US 2006/0264327 A1
(43) Pub. Date: Nov. 23, 2006

(54) Thermo-sensitive recording medium, thermo-sensitive recording device, and thermo-sensitive recording method for the same

(75) Inventor: Jae-Hwan Kim, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/360,468

(22) Filed: Feb. 24, 2006

(30) Foreign Application Priority Data
May 21, 2005 (KR) 2005-0042775

(51) Int. Cl. B41M 5/20

(52) U.S. Cl. 503/204

(57) ABSTRACT

A thermo-sensitive recording medium, a thermo-sensitive recording device, and a thermo-sensitive recording method for the same are provided. The medium includes a thermo-sensitive magnetic recording layer with a matrix resin, a first thermo-sensitive recording layer, a second thermo-sensitive recording layer, and a support layer. The matrix resin is heated to a temperature higher than the first development temperature to become fluid. The thermo-sensitive magnetic recording layer contains magnetic particles whose outer surfaces are colored with the first color dispersed in the matrix resin. The first thermo-sensitive recording layer is heated to a second development temperature to produce the second color. The second thermo-sensitive recording layer is heated to a third development temperature to produce the third color. The support layer supports the thermo-sensitive magnetic recording layer, the first thermo-sensitive recording layer, and the second thermo-sensitive recording layer.

### CROSS-REFERENCE TO RELATED PATENT APPLICATION

This application claims the benefit under 35 U.S.C. §119(a) of Korean Patent Application No. 10-2005-0042775, filed on May 21, 2005, in the Korean Intellectual Property Office, the entire disclosure of which is hereby incorporated by reference.

### BACKGROUND OF THE INVENTION

1. Field of the Invention

The present invention relates to a thermo-sensitive recording medium, a thermo-sensitive recording device, and a thermo-sensitive recording method for the same. More particularly, the present invention relates to a thermo-sensitive recording medium, a thermo-sensitive recording device, and a thermo-sensitive recording method for the same that utilize a thermo-sensitive magnetic recording layer to produce a full-color image.

2. Description of the Related Art

The methods for printing a predetermined image on a recording medium can be generally classified as either indirect printing or direct printing. Direct printing refers to a process of recording that is directly performed on a recording medium (that is, a material to be printed) by a recording device. To produce a full-color image by direct printing, at least three basic colors should be produced and, these colors should be produced independently. Recently, active efforts have been made to produce full-color images using direct printing.

FIG. 1 illustrates a sectional view of a thermo-sensitive recording paper which is disclosed in Japanese patent publication No. 3-2886888 (which is hereby incorporated by reference in its entirety). As illustrated in FIG. 1, a thermo-sensitive paper 50 includes a base layer 10, a cyan recording layer 20, a magenta recording layer 30, and a yellow recording layer 40 that are sequentially stacked on the base layer 10. Here, the thermo-sensitive recording layers 20, 30, and 40 produce different colors, respectively, as they reach set development temperatures, respectively. In this example, the recording layers 20, 30, and 40 produce cyan, magenta, and yellow colors. A protective layer 45 covers and prevents thermal and mechanical damage to the thermo-sensitive recording layers 20, 30, and 40.

FIG. 2 illustrates a thermo-sensitive printer for recording information on the thermo-sensitive recording paper of FIG. 1. The thermo-sensitive recording paper 50 is wound on a roll, and transferred in one direction while development recording is performed. First, the yellow recording layer 40 is developed. Relatively low thermal energy is applied from the first thermal head 60Y to develop the yellow recording layer 40. Subsequently, a fixing operation is performed on the yellow recording layer 40. That is, the first ultraviolet lamp 70Y (which emits light having a wavelength of about 420 nm) is illuminated on the development record so that the image formed on the yellow recording layer 40 is not damaged in spite of any further heating and developing operations. Next, medium-level thermal energy is applied from the second thermal head 60M to develop the magenta recording layer 30. Subsequently, the second ultraviolet lamp 70M (which emits light having a wavelength of about 385 nm) is illuminated to fix the magenta recording layer 30. Last, high-level thermal energy is applied from the third thermal head 60C to develop the cyan recording layer 20.

Since a separate fixing operation must be performed for each of the three different colors, total processing time is increased. Further, the recording device requires at least two or more ultraviolet lamps having different wavelengths, which increases the manufacturing cost of the recording device.

Another structure to produce full-color images using direct printing is disclosed in U.S. Pat. No. 4,665,410, which discloses a multi-color thermo-sensitive recording material, and which is hereby incorporated by reference in its entirety. The disclosed recording material has a structure in which thermo-sensitive coloring layers and decolorizing intermediate layers are alternately overlaid on a support layer. The decolorizing intermediate layers fix a developed layer after a layer has been developed. This structure has the advantage that it records three thermo-sensitive coloring layers using only one thermal head. However, precise control of the thermal head is required to meet the different development conditions of the respective thermo-sensitive coloring layers. Also, when accuracy in controlling the thermal head deteriorates, image quality deteriorates.

Accordingly, there is a need for an improved thermo-sensitive recording medium, thermo-sensitive recording device, and a thermo-sensitive recording method for the same that produces high quality images.

### SUMMARY OF THE INVENTION

An aspect of the present invention is to address at least the above problems and/or disadvantages and to provide at least the advantages described below. Accordingly, an aspect of the present invention is to provide a thermo-sensitive recording medium, a thermo-sensitive recording device, and a thermo-sensitive recording method for the same, which are capable of producing high quality images having clear colors and defined edges.

Another aspect of the present invention is to provide a thermo-sensitive recording medium, a thermo-sensitive recording device, and a thermo-sensitive recording method for the same, which are capable of reducing printing costs while producing high quality images.

According to one aspect of the present invention, a thermo-sensitive recording medium includes a thermo-sensitive magnetic recording layer having a matrix resin. When the matrix resin is heated to a temperature higher than a first development temperature, which is a transition temperature, it becomes fluid. Magnetic particles whose outer surfaces are colored with a first color are dispersed in the matrix resin. A first thermo-sensitive recording layer is heated to a second development temperature which is preferably higher than the first development temperature to produce a second color. A second thermo-sensitive recording layer is heated to a third development temperature which is preferably higher than the second development temperature to produce a third color. A support layer supports the thermo-sensitive magnetic recording layer, the first thermo-sensitive recording layer, and the second thermo-sensitive recording layer. The first color, second color, and third color are developed independently and combined with one another to produce a multi-color image.

The colors may be yellow, magenta, and cyan, in any order. For example, the first color may be cyan, the second color may be magenta, and the third color may be yellow.

The magnetic particles may be concentrated on the upper surface or the lower surface of the matrix resin, with one surface being opposite to a display direction. Also, the matrix resin may include a polymer resin that is opaque with respect to light.

The first thermo-sensitive recording layer may be developed at a relatively low temperature and may be disposed at an inner side of the medium. The second thermo-sensitive recording layer may be disposed at an outer side of the medium. An intermediate blocking layer may be interposed between the first thermo-sensitive recording layer and the second thermo-sensitive recording layer.

According to another aspect of the present invention, a thermo-sensitive recording medium on which a multi-color image is produced is provided. The image is produced by thermo-sensitive recording and magnetic recording that are performed independently, and the image is visible from an upper side of the medium. The recording medium includes a support layer, a thermo-sensitive magnetic recording layer formed on the support layer. The thermo-sensitive magnetic recording layer has a matrix resin which when heated to a temperature higher than a first development temperature, which is a transition temperature, becomes fluid. The thermo-sensitive magnetic recording layer has magnetic particles uniformly dispersed at a lower side of the matrix resin, and the outer surfaces of the magnetic particles are colored with a first color. A first thermo-sensitive recording layer is formed on the thermo-sensitive magnetic recording layer and is heated to a second development temperature which is preferably higher than the first development temperature to produce a second color. A second thermo-sensitive recording layer is formed on the first thermo-sensitive recording layer and is heated to a third development temperature which is preferably higher than the second development temperature to produce a third color.

According to another aspect of the present invention, a thermo-sensitive recording medium on which a multi-color image is produced is provided. The image is produced by thermo-sensitive recording and magnetic recording that are performed independently, and the image is visible from an upper side of the medium. The thermo-sensitive medium includes a support layer which is transparent with respect to light. A thermo-sensitive magnetic recording layer is formed on the support layer and has a matrix resin which, when heated to a temperature higher than a first development temperature, which is a transition temperature, becomes fluid. Magnetic particles are substantially uniformly dispersed in an upper side of the matrix resin and the outer surfaces of the magnetic particles are colored with a first color. A first thermo-sensitive recording layer is formed under the support layer and is heated to a second development temperature which is preferably higher than the first development temperature to produce a second color. A second thermo-sensitive recording layer is formed under the first thermo-sensitive recording layer and is heated to a third development temperature which is preferably higher than the second development temperature to produce a third color.

According to another aspect of the present invention, a thermo-sensitive recording device receiving the above-described thermo-sensitive recording medium to produce a multi-color image on the thermo-sensitive recording medium is provided. The recording device includes at least one thermal head that supplies thermal energy to perform image-forming while scanning at least closely positioned with respect to the thermo-sensitive recording medium. A magnetic head operates simultaneously with the at least one thermal head and supplies magnetic force to perform image-forming while scanning at least closely positioned with respect to the thermo-sensitive recording medium.

The thermal-heads may have, preferably very small-sized, heat-emitting resistors formed in parallel. The magnetic head may have, preferably very small-sized, magnetic poles formed in parallel.

According to another aspect of the present invention, a thermo-sensitive recording device receiving the above-described thermo-sensitive recording medium to produce a multi-color image on the thermo-sensitive recording medium is provided. The recording device includes a transfer means for transferring the thermo-sensitive recording medium back and forth along a delivery path. A thermal head is disposed at an upper portion of the delivery path and supplies thermal energy to perform image-forming while scanning at least closely positioned with respect to the thermo-sensitive recording medium delivered by the transfer means. A magnetic head is disposed after the thermal head at an upper portion of the delivery path, and operates simultaneously with the thermal head. The magnetic head supplies magnetic force to perform image-forming while scanning at least closely positioned with respect to the thermo-sensitive recording medium.

The thermal head may heat the first thermo-sensitive recording layer and the second thermo-sensitive recording layer of the thermo-sensitive recording medium to the second development temperature and the third development temperature, respectively, to produce the second color and the third color. The thermal head and the magnetic head operate together with respect to the thermo-sensitive magnetic recording layer of the thermo-sensitive recording medium to produce the first color.

The recording device may further include a cooling head disposed after the magnetic head at an upper portion of the delivery path. The cooling head forcibly cools the thermo-sensitive magnetic recording layer that has been developed and recorded by the magnetic head.

According to another aspect of the present invention, a thermo-sensitive recording device receiving the above-described thermo-sensitive recording medium to produce a multi-color image on the thermo-sensitive recording medium is provided. The recording device includes a transfer means for transferring the thermo-sensitive recording medium back and forth along a delivery path. A first thermal head is disposed at a lower portion of the delivery path and supplies thermal energy to perform image-forming while scanning at least closely positioned with respect to the thermo-sensitive recording medium delivered by the transfer means. A second thermal head is disposed at an upper portion of the delivery path and supplies thermal energy to perform image-forming while scanning at least closely positioned with respect to the thermo-sensitive recording medium delivered by the transfer means. A magnetic head is disposed after the second thermal head at a lower portion of the delivery path, and operates simultaneously with the second thermal head. The magnetic head supplies magnetic force to perform image-forming while scanning at least closely positioned with respect to the thermo-sensitive recording medium.

The first thermal head may heat the first thermo-sensitive recording layer and the second thermo-sensitive recording layer of the thermo-sensitive recording medium to the second development temperature and the third development temperature, respectively, to produce the second color and the third color. The second thermal head and the magnetic head may operate simultaneously with respect to the thermo-sensitive magnetic recording layer of the thermo-sensitive recording medium to produce the first color.

Both of the thermal head and the magnetic head may be elastically biased towards pressure rollers formed on an opposite side of the delivery path. The thermo-sensitive recording medium may be thermo-sensitive recorded or magnetic-recorded while contacting the thermal head and the magnetic head.

According to another aspect of the present invention a thermo-sensitive recording device for producing a multi-color image on the above-described thermo-sensitive recording medium is provided. The recording device includes a transfer means for transferring the thermo-sensitive recording medium along one direction on a delivery path. A head unit is mounted on a driving belt that rotates around the delivery path. The head unit includes at least one thermal head that supplies thermal energy to perform image-forming while scanning at least closely positioned with respect to the thermo-sensitive recording medium, and a magnetic head mounted in parallel with the thermal head. The magnetic head operates with the thermal head, and supplies magnetic force to perform image-forming while scanning at least closely positioned with respect to the thermo-sensitive recording medium.

According to another aspect of the present invention, a thermo-sensitive recording method for producing multi-color visual information on a thermo-sensitive recording medium having a first thermo-sensitive recording layer, a second thermo-sensitive recording layer, and a thermo-sensitive magnetic recording layer that have independent development conditions, respectively, is provided. The method includes the steps of heating the first thermo-sensitive recording layer to a first development temperature to produce a first color, heating the second thermo-sensitive recording layer to a second development temperature to produce a second color, heating the thermo-sensitive magnetic recording layer to a temperature higher than a third development temperature, which is a transition temperature, to cause a matrix resin included in the thermo-sensitive magnetic recording layer to become fluid, and providing magnetic force to force colored magnetic particles contained in the matrix resin to a display direction of an image, thereby producing a third color.

The method may further include the step of cooling the thermo-sensitive magnetic recording layer to a temperature lower than the transition temperature to fix a display position of the magnetic particles after heating the thermo-sensitive magnetic recording layer.

### BRIEF DESCRIPTION OF THE DRAWINGS

The above and other objects, features, and advantages of certain exemplary embodiments of the present invention will be more apparent from the following description taken in conjunction with the accompanying drawings, in which:

FIG. 1 is a sectional view of a thermo-sensitive recording paper disclosed in Japanese Patent Publication No. 3-2886888;

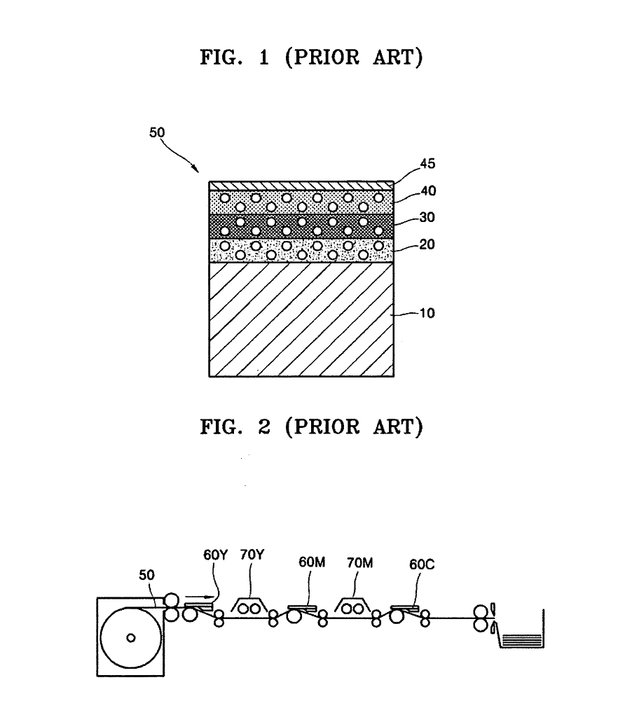

FIG. 2 is a view of a thermo-sensitive printer that records information on the thermo-sensitive recording paper of FIG. 1,

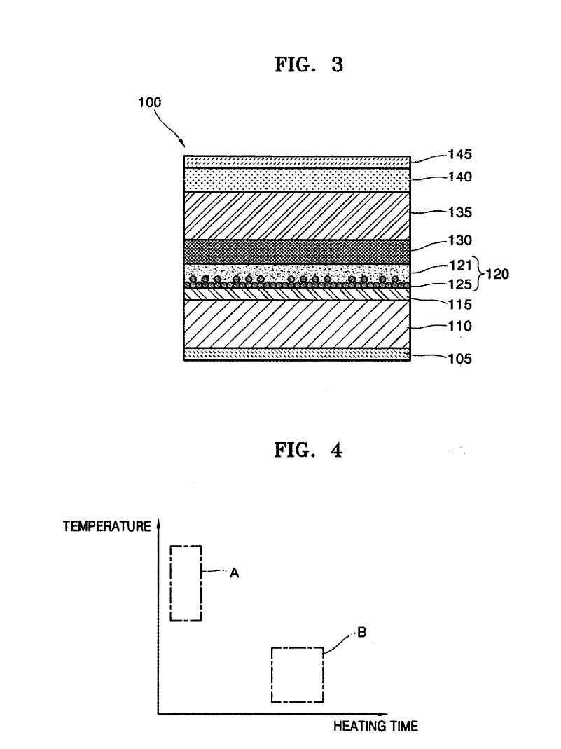

FIG. 3 is a sectional view of a thermo-sensitive recording medium according to an exemplary embodiment of the present invention;

FIGS. 4 and 5 are views illustrating different thermo-sensitive characteristics of the first thermo-sensitive recording layer and the second thermo-sensitive recording layer and an example of thermo-sensitive recording types thereof, respectively;

FIG. 6 is a sectional view of a thermo-sensitive recording medium according to another exemplary embodiment of the present invention;

FIG. 7 is a schematic view of a thermo-sensitive recording device according to one exemplary embodiment of the present invention;

FIGS. 8A through 8D are views explaining operations of the thermo-sensitive recording device of FIG. 7;

FIG. 9 is a schematic view of a thermo-sensitive recording device according to another exemplary embodiment of the present invention;

FIG. 10A through 10D are views explaining operations of the thermo-sensitive recording device of FIG. 7;

FIG. 11 is a schematic view of a thermo-sensitive recording device according to yet another exemplary embodiment of the present invention; and

FIG. 12 is a view of the thermo-sensitive recording device of FIG. 11 in the direction indicated by the arrow XII in FIG. 11.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the exemplary embodiments of the invention. Accordingly, those of ordinary skill in the art will recognize that various changes and modifications of the exemplary embodiments described herein can be made without departing from the scope and spirit of the invention. Also, descriptions of well-known functions and constructions are omitted for clarity and conciseness.

Exemplary embodiments of the present invention will now be described more fully with reference to the accompanying drawings.

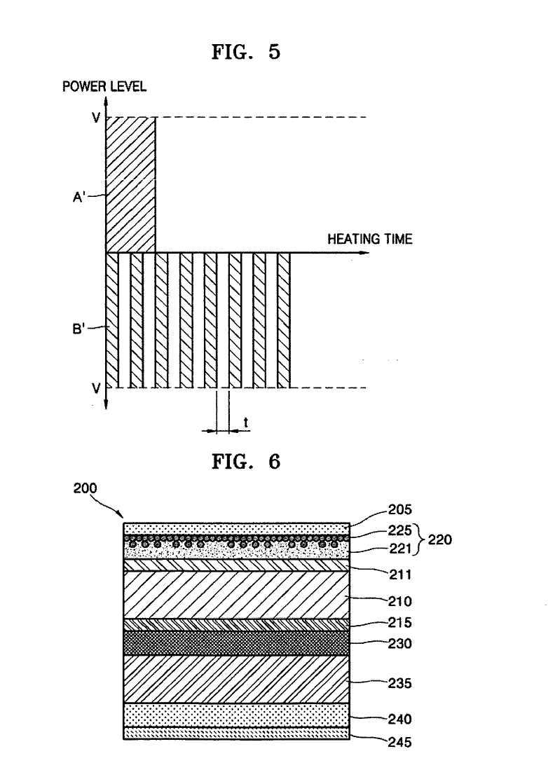

FIG. 3 is a sectional view of a thermo-sensitive recording medium according to one exemplary embodiment of the present invention. The thermo-sensitive recording medium has a thermo-sensitive magnetic recording layer 120, a first thermo-sensitive recording layer 130, and a second thermo-sensitive recording layer 140 sequentially stacked on one side (front side in the drawing) of a support layer 110. In the illustrated thermo-sensitive recording layer, recording is performed on only one side of the support layer 110 and an image is viewed by looking downwards towards the top of FIG. 3.

The support layer 110 serves as a support for the recording layers 120, 130, and 140 stacked thereon. The support layer 110 may be any suitable material and structure as known to those skilled in the art. For example, polyester type resin, polyvinyl chloride, polystyrene type resin, or an acryl type resin formed in a film can be used for the support layer 110. In an exemplary embodiment, the recording layers 120, 130, and 140 are stacked on one side of the support layer 110 and the support layer 110 does not need to be transparent to light.

The first thermo-sensitive recording layer 130 and the second thermo-sensitive recording layer 140 consist of a dye layer activated by heat from a heat-emitting element to take on a predetermined color. The thermo-sensitive recording layer can include a development material that is directly or indirectly developed by heat transferred from the thermal head. A material which is directly developed by heat may be a developing material whose structure itself changes at a predetermined temperature, a developing material whose crystalline structure changes at a predetermined temperature, or a developing material that develops as part of the layer is driven off by the heat. The material indirectly developed by the heat may be a compound of a developer and a color precursor, or a compound of a microcapsule having a developer or a coupler and a color precursor. The developer means a material that is activated at a predetermined temperature to create acid and the color precursor means a material that reacts to the acid to develop a color. Also, the microcapsule may be formed of a material where the transmittance of the developer, the coupler, or the color precursor changes at a predetermined temperature. The color precursor may be a leuco dye. The leuco dye may be lactone, fluoran, phenothiazine, and triaryl pyridine leuco dye. The developer may be an organic acid material.

The thermo-sensitive recording layers 130 and 140 may be a synthetic resin which is transparent to light and which has excellent film-forming characteristics. For example, the synthetic resin may be gelatin, polyvinyl chloride, polystyrene, polyester, polyurethane, polycarbonate, polyacrylate, and polyvinyl alcohol.

The first thermo-sensitive recording layer 130 and the second thermo-sensitive recording layer 140 should have different developed colors and should be developed independently, so that a desired multi-color image can be produced. That is, the thermo-sensitive recording layers 130 and 140 are delivered by the transfer means and heated by the thermal head having heat-emitting elements mounted thereon. The thermo-sensitive recording layers 130 and 140 are heated to appropriate temperatures to activate and develop the colors. For example, when the first thermo-sensitive recording layer 130 on the lower side is heated and developed after the second thermo-sensitive recording layer 140 on the upper side is heated and developed, the second thermo-sensitive recording layer 140 on which a predetermined image has already been formed might be additionally developed by a later heating process intended for the first thermo-sensitive recording layer 130. This might damage the original image or blur the outline of the original image. To avoid such unnecessary thermal interference, the dye layers in the thermo-sensitive recording layers 130 and 140 may have different development conditions.

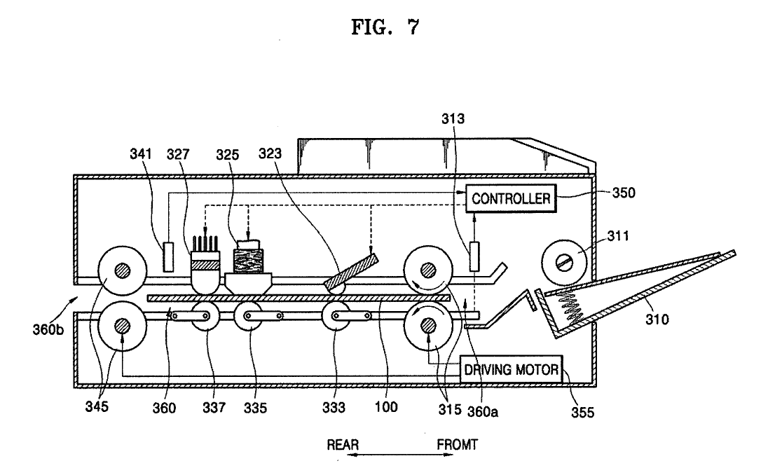

FIG. 4 schematically illustrates the development conditions of the first and second thermo-sensitive recording layers 130 and 140. In FIG. 4, the region denoted by the reference numeral A is a region that satisfies the development condition of the second thermo-sensitive recording layer and the region denoted by the reference numeral B is a region that satisfies the development condition of the first thermo-sensitive recording layer. Referring to FIG. 4, these thermo-sensitive recording layers 130 and 140 have different development temperatures. In detail, the lowest development temperature in the range of development temperatures for developing the second thermo-sensitive recording layer 140 may be higher than the highest development temperature in the range of development temperatures for developing the first thermo-sensitive recording layer 130. Also, the second thermo-sensitive recording layer 140 is developed by heating for a short period of time, but the first thermo-sensitive recording layer 130 is developed by heating for a long period of time.

For practical reasons, developing the different layers by heating the thermo-sensitive recording layers 130 and 140 to the same temperature, rather than heating them to different temperatures, may be more convenient and less costly. FIG. 5 schematically illustrates a method of heating such that the first thermo-sensitive recording layer 130 and the second thermo-sensitive recording layer 140 may be developed independently while using the same heat source. In FIG. 5, a region denoted by A′ is a heating profile for the second thermo-sensitive recording layer 140 and a region denoted by B′ is a heating profile for the first thermo-sensitive recording layer 130. The second thermo-sensitive recording layer 140 requires high thermal energy for a short period of time, and it is possible to activate the second thermo-sensitive recording layer 140 by applying thermal energy of a predetermined level V in a concentrated manner. In contrast, the first thermo-sensitive recording layer 130 requires low thermal energy for a long period of time, and it is possible to satisfy the development condition of the first thermo-sensitive recording layer 130 by applying thermal energy of the same level V for a long period of time with a predetermined time interval ‘x’. For example, in the case of applying a thermal head formed by connecting a predetermined current or voltage source to heat-emitting elements consisting of electrical resistors, the thermal energy means a current or voltage applied to the heat-emitting elements.

When an intermediate blocking layer 135 is interposed between the first and second thermo-sensitive recording layers 130 and 140, thermal flow that might occur during thermo-sensitive recording can be blocked, which contributes to allowing the two layers 130 and 140 to be developed independently. That is, the intermediate blocking layer 135 serves to block heat so that heat applied to the second thermo-sensitive recording layer 140 on the upper side may not flow to the first thermo-sensitive recording layer 130 on the lower side. The intermediate blocking layer 135 may be formed of any appropriate material, including a material that experiences phase transition when heated, such as an inactive material or a layer that includes thermal solvent. For example, the intermediate blocking layer 135 may be formed of a polymer film such as polyvinyl alcohol.

The thermo-sensitive magnetic recording layer 120 may consist of a mixture where magnetic particles 125 are mixed in the matrix resin 121. The matrix resin 121 may be formed of a polymer synthetic resin having a low transition temperature. More specifically, the transition temperature may be set to a temperature lower than the development temperatures of the first and second thermo-sensitive recording layers 130 and 140. The matrix resin 121 may be a hydrocarbon resin material. The matrix resin 121 has a great change in its fluidity at the boundary of the transition temperature. That is, when heated to a temperature higher than the transition temperature, the matrix resin 121 has fluidity approaching fluid so that the magnetic particles 125 mixed therein can be pulled by external magnetic force and moved upward. In contrast, when the matrix resin 121 is cooled to a temperature lower than the transition temperature, the matrix resin 121 loses fluidity to transition to a solid phase, so that movement of the magnetic particles 125 is prevented.

The magnetic particles 125 mixed in the matrix resin 121 are concentrated at the boundary between the matrix resin 121 and the support layers 110. The magnetic particles 125 may be uniformly dispersed over a whole image-forming area. The magnetic particles 125 may be a metal powder such as binder solidified fine powder ferrite, spherical sintered ferrite, fine powder sintered ferrite, or a crystal ferrite.

The magnetic particles 125 are colored with a predetermined color. For example, the outer surfaces of the magnetic particles 125 may be coated with a coloring dye to produce a predetermined color. The thermo-sensitive magnetic recording layer 120 can be formed by coating the matrix resin 121 containing the magnetic particles 125 dispersed therein on the support layer 110 using any conventional method and by a firing-drying process. The support layer 110 and the matrix resin 121 may not adhere to one another if they are formed of a polyester and oil, respectively. In that case, an undercoating layer 115 may be interposed between the support layer 110 and the thermo-sensitive magnetic recording layer 120 to facilitate coupling between the layers. The undercoating layer 115 may be formed of a material selected from the group consisting of a two-compound primer of polyol and polyisocyanate, and a one-compound primer such as acryl, urethane, acryl-urethane series, and vinyl.

The matrix resin 121 performs a blocking function so that the color of the magnetic particles 125 contained in the lower portion of the matrix resin 121 are not visible from the outside. For that purpose, the matrix resin 121 may be opaque. In detail, the matrix resin 121 may be a white color as a background color with respect to the thermo-sensitive recording layers 130 and 140 to produce a predetermined image thereon. For that purpose, the matrix resin 121 can contain an appropriate reflective material or particles of a white pigment such as titanium dioxide.

A protective layer 145 may be disposed on the uppermost portion of the thermo-sensitive recording medium. The protective layer 145 shields and protects the respective recording layers 120, 130, and 140 from thermal environments or external influences. The protective layer 145 may be a resin having both thermal endurance and flexibility. Since the thermo-sensitive recording medium is heated and cooled several times while recording a predetermined image on the medium, thermal endurance and flexibility are required to substantially protect the inner structure without detaching from the medium. A lower side protective layer 105 can-be further disposed on the opposite side of the support layer 110 on which the recording layers 120, 130, and 140 are stacked. The lower side protective layer protects the support layer 110 from exposure to the outside environment.

The thermo-sensitive magnetic recording layer 120, the first thermo-sensitive recording layer. 130, and the second thermo-sensitive recording layer 140 produce different colors. The colors developed by these layers are combined to form a full-color image. For example, the thermo-sensitive magnetic recording layer 120 can have a developed color of cyan, the first thermo-sensitive recording layer 130 can have a developed color of magenta, and the second thermo-sensitive recording layer 140 can have a developed color of yellow. These three basic colors are combined to produce a full-color image.

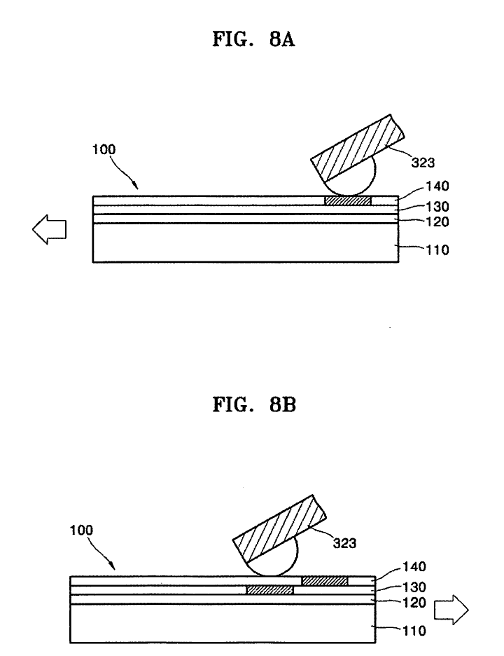

FIG. 6 is a sectional view of a thermo-sensitive recording medium according to another exemplary embodiment of the present invention. The illustrated thermo-sensitive recording medium 200 includes a support layer 210 and recording layers 220, 230, and 240 directly or indirectly supported by the support layer 210. Here, the thermo-sensitive recording medium of this exemplary embodiment has a first thermo-sensitive recording layer 230 and a second thermo-sensitive recording layer 240 at the lower side of the support layer 210 and has a thermo-sensitive magnetic recording layer 220 at the upper side of the support layer 210. The first and second thermo-sensitive recording layers 230 and 240 should be developed independently without influencing each other so as to obtain a desired multi-color image using combination of these layers. Therefore, unnecessary thermal interference between them is prevented by making the heating temperatures or heating times different during the first thermo-sensitive recording operation and the second thermo-sensitive recording operation.

Since the thermo-sensitive recording medium has the recording layers 220, 230, and 240 formed on the different sides of the support layer 210, thermal interference between the thermo-sensitive magnetic recording layer 220 formed on the upper side of the support layer 210 and the first and second thermo-sensitive recording layers 230 and 240 formed on the lower side of the support layer 210 is prevented. That is, the support layer 210 is formed as a relatively thick film and serves as an adiabatic layer. Therefore, an image already formed on the first and second thermo-sensitive recording layers 230 and 240 is not damaged by thermal energy applied during the thermo-sensitive magnetic recording operation. This means that the operating environment of the thermo-sensitive magnetic recording does not need to be precisely controlled and thus process efficiency improves.

Since the colors of the recording layers 220, 230, and 240 formed on both sides of the support layer 210 are combined to produce a multi-color image on thermo-sensitive recording medium of the second exemplary embodiment, the support layer 210 may be formed of a light-transparent material. For example, the support layer 210 may be formed of a polymer film such as polyethylene terephthalate (PET).

An intermediate blocking layer 235 that substantially blocks thermal flow between the first and second thermo-sensitive recording layers 230 and 240 may be further provided between them. Also, undercoating layers 211 and 215 are interposed on both sides of the support layer 210 to facilitate bonding between the thermo-sensitive magnetic recording layer 220 and the support layer 210 and between the thermo-sensitive recording layer 230 between the support layer 210. Protective layers 205 and 245 are disposed on the surfaces of the thermo-sensitive recording medium 200 to protect the layered structures. Reference numerals 221 and 225 in FIG. 6 represent the matrix resin 221 included in the thermo-sensitive magnetic recording layer 220 and magnetic particles dispersed in the matrix resin 221, respectively.

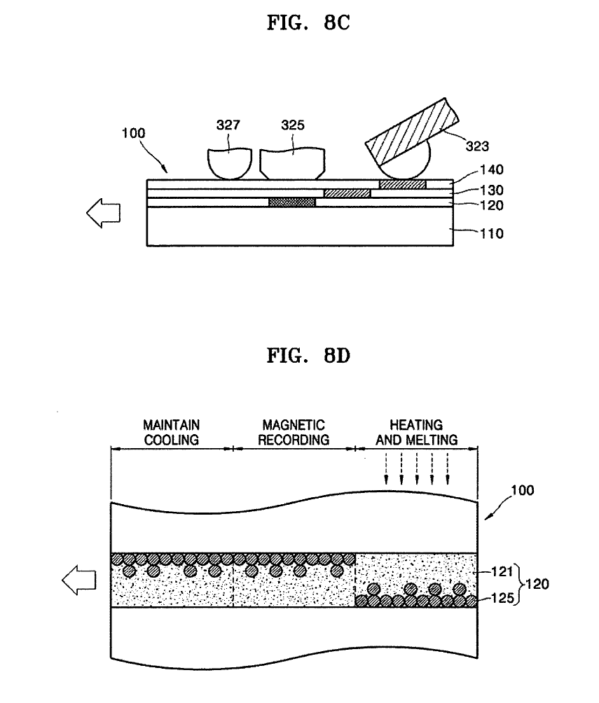

FIG. 7 is a schematic view of a thermo-sensitive recording device for activating the thermo-sensitive recording medium of FIG. 3 to record visual information. The device includes a feeding cassette 310, a feeding roller 311 that supplies a thermo-sensitive recording medium 100 loaded in the feeding cassette 310, transfer rollers 315 and 345 that transfer the supplied thermo-sensitive recording medium 100 along a delivery path 360, and heads 323, 325, and 327 that record by applying heat or magnetic force on one side of the transferred thermo-sensitive recording medium 100. In more detail, the thermo-sensitive recording medium 100 is fit between a pair of front transfer rollers 315 and transferred to the inside of the device. During the transfer process, information is recorded on the thermo-sensitive recording medium 100. One of the transfer rollers 315 can be a driving roller operated by a driving motor 355 and the other can be an idle roller rotating on its own axis while being pressed by the driving roller. The thermo-sensitive recording medium 100 receives a predetermined transferring force while passing between the driving roller and the idle roller. The transfer rollers 315 and 345 can be symmetrically installed at the front and rear of the delivery path 360, and the rear transfer rollers 345 can have substantially the same structure as that of the front transfer rollers 315.

A thermal head 323, a magnetic head 325, and a cooling head 327 are sequentially disposed along the delivery path 360 of the thermo-sensitive recording medium 100. These heads record image information on the thermo-sensitive recording medium 100 while having thermal interaction or magnetic interaction, with the thermo-sensitive recording medium 100. Here, the thermal head 323 has heat-emitting elements in parallel along the width direction of the thermo-sensitive recording medium 100. The heat-emitting elements may include very-small sized heat-emitting electrical resistors A predetermined current is applied to the heat-emitting elements through a controller 350 and the controller 350 allows the thermo-sensitive recording medium 100 to be raised to a predetermined temperature by controlling the amount and application time of current. The thermal head 323 is preferably elastically biased towards a pressure roller 333 facing the thermal head 323 by an elastic member (not shown). The thermo-sensitive recording medium 100 maintains contact with the thermal head 323 and is heated to a development temperature while passing between the thermal head 323 and the pressure roller 333.

The magnetic head 325 is also preferably biased towards a pressure roller 335 formed on the opposite side of the delivery path 360 by an elastic member (not shown). The magnetic head 325 maintains contact with the thermo-sensitive recording medium 100 which passes between the magnetic head 325 and the pressure roller 335. The magnetic head 325 has small magnetic poles installed in parallel along the width direction of the magnetic head 325. The small magnetic poles can be permanent magnets or electromagnets. When the magnetic head 325 has permanent magnets, the permanent magnets are moved down (preferably through gravity) to approach the thermo-sensitive recording medium 100 or moved up and away from the thermo-sensitive recording medium 100 to control the on or off status of the magnetic force.

The cooling head 327 is disposed adjacent to the magnetic head 325. The cooling head 327 forcibly cools the thermo-sensitive recording medium 100 after image-forming is performed by the magnetic head 325. The cooling head 327 is preferably elastically pressed against the pressure roller 337 formed on the opposite side of the delivery path 360. The cooling head 327 can be a known thermo-electric conversion module including metal or a semiconductor that uses the Peltier effect. When a current is applied to the cooling head, temperature is lowered due to the Peltier effect.

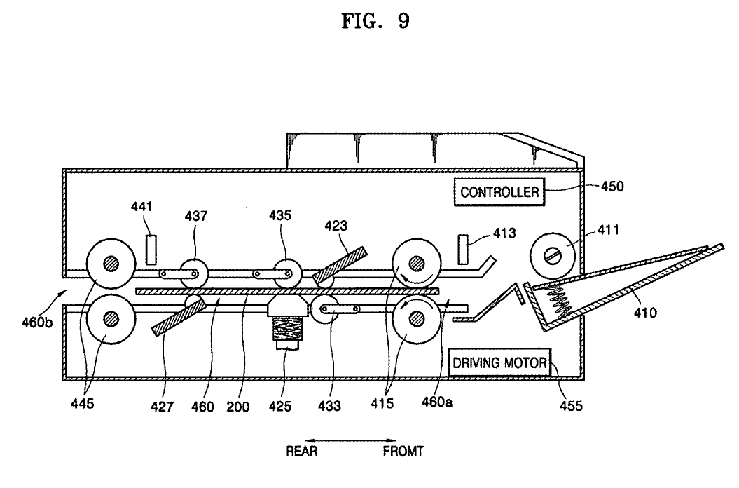

FIGS. 8A through 8D illustrate sectional views of a thermo-sensitive recording medium where a predetermined region is developed for each recording operation. The illustration of the thermo-sensitive recording medium has been simplified for convenience in explanation.

In operation, when the thermo-sensitive recording medium 100 is inserted into the inside of the device from a front open end 360a, the first thermo-sensitive recording operation is performed while the thermo-sensitive recording medium 100 is transferred in one direction along the delivery path 360 by the pair of transfer rollers 315. That is, the thermo-sensitive recording medium 100 contacts the thermal head 323 installed at the upper side of the delivery path 360 and the second thermo-sensitive recording layer 140 is activated while contacting the thermal head 323. That is, the thermal head 323 has heat-emitting resistors installed in parallel and a predetermined current is applied to the heat-emitting resistors by the controller 350, so that the second thermo-sensitive recording layer 140 is heated to a development temperature. In FIG. 8A, a predetermined region of the second thermo-sensitive recording layer 140 is activated and developed.

When the thermo-sensitive recording medium 100 reaches a rear open end 360b, the rear transfer rollers 345 is driven in reverse and the thermo-sensitive recording medium 100 is transferred back to the front. A position detection sensor 341 is installed at the side of the rear open end 360b so that arrival of the thermo-sensitive recording medium 100 can be detected and the rotational direction of the transfer rollers 345 can be reversed. The thermo-sensitive recording medium 100 contacts the thermal head 323 again while being transferred to the front and the second thermo-sensitive recording is performed. That is, the thermal head 323 applies predetermined thermal energy on the thermo-sensitive recording medium 100 to activate the first thermo-sensitive recording layer 130. In more detail, a predetermined current that corresponds to the development temperature of the first thermo-sensitive recording layer 130 is applied to the thermal head 323 by the controller 350.

FIG. 8B illustrates a predetermined region of the first thermo-sensitive recording layer 130 which is developed. The first thermo-sensitive recording layer 130 may be heated to a temperature lower than the second thermo-sensitive recording layer 140 (otherwise the second thermo-sensitive recording layer 140 which was already developed might be activated again). If the second thermo-sensitive recording layer 140 is developed again, the edges of the image become unclear and image quality deteriorates. At this point, heating times can be different. For example, the second thermo-sensitive recording layer 140 can be heated at a high temperature for a short period of time and the first thermo-sensitive recording layer 130 can be heated at a low temperature for a long period of time. As described above, the different colors can be developed independently by the thermo-sensitive recording layers 130 and 140 having different thermo-sensitive characteristics.

When the thermo-sensitive recording medium 100 passes by the thermal head 323 and approaches the front open end 360a, the front transfer rollers 315 are reversely rotated on the basis of a signal outputted from a front position detection sensor 313 installed at the upper portion of the delivery path 360. Thus, the thermo-sensitive recording medium 100 is transferred to the rear again and the thermo-sensitive magnetic recording operation is performed. Here, the thermal head 323 and the magnetic head 325 are simultaneously driven to form an image on the thermo-sensitive magnetic recording layer. FIG. 8C is a sectional view of the thermo-sensitive recording medium where a predetermined region of the thermo-sensitive magnetic recording layer 120 is developed and FIG. 8D illustrates a state change of the thermo-sensitive magnetic recording layer 120 from beginning to ending of the thermo-sensitive magnetic recording. The thermo-sensitive recording medium 100 sequentially contacts the thermal head 323 and the magnetic head 325. The matrix resin 121 heated by the thermal head 323 is heated to a transition temperature thereof to make the resin fluid, so that the magnetic particles 125 contained therein move freely. A predetermined magnetic force is applied on the thermo-sensitive magnetic recording layer 120 when the thermo-sensitive magnetic recording layer 120 contacts the magnetic head disposed after the thermal head 323. The magnetic particles 125 contained in the thermo-sensitive magnetic recording layer 120 are raised due to the influence of the magnetic force. In more detail, the magnetic head 325 has small magnetic poles installed in parallel along the width direction of the magnetic head 325. When the small magnetic poles consist of electromagnets, a current is applied to the small magnetic poles on an image-forming portion and the current is cut-off for the magnets disposed on a non-image-forming portion. The magnetic particles 125 are raised to the surface of the thermo-sensitive magnetic recording layer 120 to develop a predetermined color through dye coated on the surfaces thereof. When the small magnetic poles consist of permanent magnets, the recording operation is performed not by controlling current but by changing the distance between the small magnetic poles and the thermo-sensitive recording medium. That is, the small magnetic poles are lowered to attract the magnetic particles 125 in an image-forming portion and the small magnetic poles are raised so that the magnetic particles 125 are not influenced in a non-image-forming portion.

Since gravity applies a downward force to the magnetic particles 125, the magnetic particles 125 which are raised by the magnetic head 325 will fall down back to the lower side and an image cannot be formed on the thermo-sensitive magnetic recording layer 120 when the matrix resin 121 is maintained in a fluid state. Therefore, after the magnetic head 325 is applied, the cooling head 327 may be subsequently driven to cool the matrix resin 121 to a substantially solid state. That is, since the matrix resin 121 is cooled to a temperature lower than the transition temperature by the cooling head 327 loses fluidity, the magnetic particles 125 are supported therein and maintained at fixed positions.

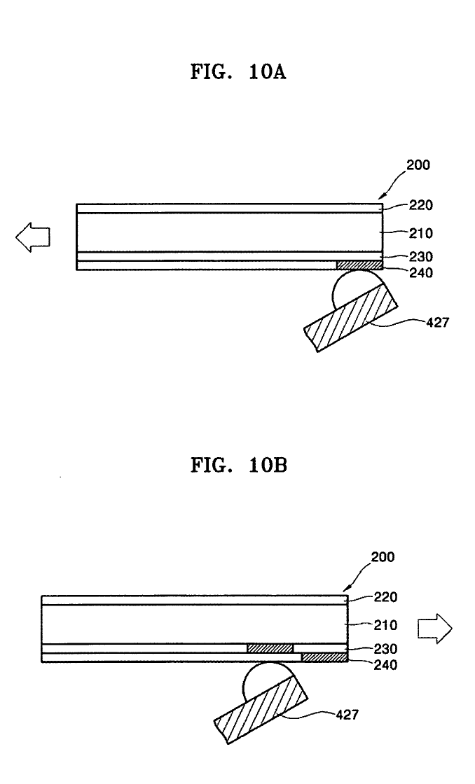

FIG. 9 illustrates a thermo-sensitive recording device that records predetermined visual information on the thermo-sensitive recording medium of FIG. 6 according to another exemplary embodiment of the present invention. The device includes a feeding roller 411 that supplies a thermo-sensitive recording medium 200 loaded in a feeding cassette 410, transfer rollers 415 and 445 that transfer the supplied thermo-sensitive recording medium 200 along a delivery path 460, and heads 423, 425, and 427 that produce a predetermined image while thermally and/or magnetically affecting the thermo-sensitive recording medium 200. The transfer rollers 415 and 445 are formed in pairs to allow the thermo-sensitive recording medium 200 to pass therebetween and be transferred while rotating and being pressed towards to each other. The transfer rollers 415 and 445 can be formed at a front open end 460a and a rear open end 460b, respectively. The transfer rollers 415 and 445 transfer the thermo-sensitive recording medium 200 back and forth to allow recording operations to be performed by the heads 423, 425, and 427 installed at the upper and lower sides of delivery path 460.

A magnetic head 425 that acts as a magnetizing means and a first thermal head 427 that acts as a heating means are installed at the lower side of the delivery path 360. The magnetic head 425 has small magnetic poles installed in parallel and the first thermal head 427 has heat-emitting elements installed in parallel. The second thermal head 423 which is driven simultaneously with the magnetic head 425 is installed at the upper side of the delivery path 460. The second thermal head 423 may also have substantially the same structure as that of the first thermal head 427. The heads 423, 425, and 427 may be elastically biased with respect to pressure rollers 433, 435, and 437 installed on the opposite side of the delivery path 460, respectively, so that the thermo-sensitive recording medium 200 may be transferred therebetween while maintaining contact with the heads 423, 425, and 427. The thermo-sensitive recording device may additionally have a controller 450. The controller 450 applies a drive signal to the heads 423, 425, and 427.

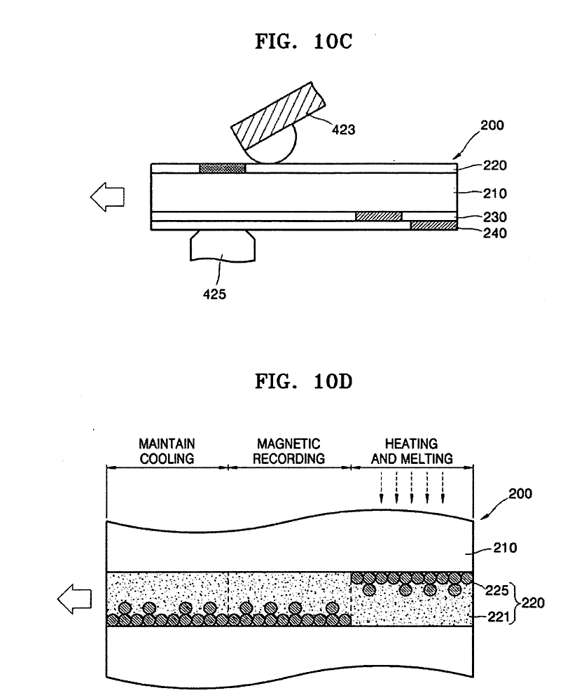

FIGS. 10A through 10D illustrate sectional views of a thermo-sensitive recording medium where a predetermined region is developed for each recording operation. The thermo-sensitive recording medium has been simplified for convenient explanation.

In operation, the thermo-sensitive recording medium 200 is inserted into the inside of the device through the front open end 460a and transferred to the front by the transfer roller 415. Referring to FIG. 10A, the thermo-sensitive recording medium 200 is heated and developed while maintaining thermal contact with the first thermal head 427. That is, the thermo-sensitive recording medium 200 is heated to a temperature at which the second thermo-sensitive recording layer 240 is activated, so that a predetermined development is performed. When the thermo-sensitive recording medium 200 reaches the rear open end,460b, a rear position detection sensor 441 installed on the delivery path 460 outputs a predetermined arrival signal to the controller 450 and the transfer rollers 445 are reversely rotated in response to the signal. Therefore, the thermo-sensitive recording medium. 200 is transferred to the front and thermally contacts the first thermal head 427 again. Here, referring to FIG. 10B, the thermo-sensitive recording medium 200 is heated to a temperature at which the first thermo-sensitive recording layer 230 is activated, so that a predetermined image is recorded with a predetermined color according to the characteristic of the thermo-sensitive recording layer 230. As the thermo-sensitive recording medium 200 reaches the front open end 460a, the controller 450 reverses the transfer rollers 415 on the basis of a signal outputted from a front position detection sensor 413, so that the thermo-sensitive recording medium 200 is transferred to the rear again. The transferred thermo-sensitive recording medium 200 thermally contacts the second thermal head 423 and subsequently magnetically contacts the magnetic head 425 installed at the lower side. That is, during this process, the second thermal head 423 and the magnetic head 425 simultaneously operate. Referring to FIGS. 10C and 10D, the thermo-sensitive recording medium 200 is heated to a temperature higher than the transition temperature of the matrix resin 221 through the thermal contact with the second thermal head 423 and becomes fluid so that the magnetic particles can move freely. In this state, when magnetic force is applied by the magnetic head 425, the colored magnetic particles 225 are attracted to the side of the magnetic head 425 and thus a predetermined image is produced. The magnetic particles 225 attracted to the lower side of the thermo-sensitive magnetic recording layer 220 maintain fixed positions due to gravitational force. Therefore, since the image will maintain its shape even when the matrix resin 221 is more or less fluid, a separate cooling head is not required.

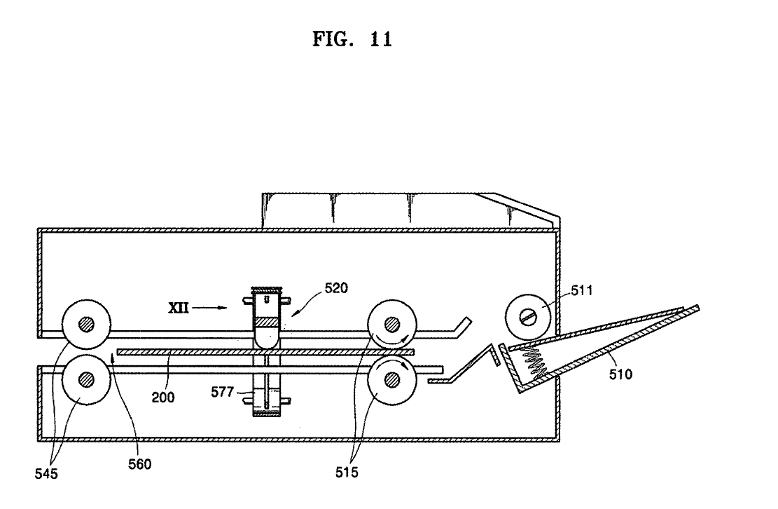

FIG. 11 illustrates a thermo-sensitive recording device that records a predetermined image on the thermo-sensitive recording medium of FIG. 6 according to another exemplary embodiment of the present invention. The device includes a feeding cassette 510, a feeding roller 511 that supplies a thermo-sensitive recording medium 200 loaded in the feeding cassette 510, transfer rollers 515 and 545 that transfer the supplied thermo-sensitive recording medium 200 along a delivery path 560, and a head unit 520 that records on the thermo-sensitive recording medium 200 while rotating around the delivery path 560.

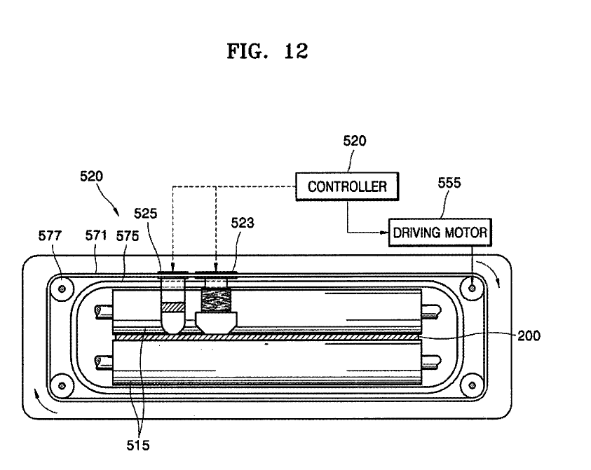

FIG. 12, which is a view explaining an operation state of the head unit of FIG. 11, illustrates the device of FIG. 11 along the direction indicated by the arrow XII in FIG. 11. Referring to FIGS. 11 and 12, the head unit 520 that includes a thermal head 523 and a magnetic head 525 is mounted on a driving belt 571. The driving belt 571 is supported by guide rollers 577 disposed at four corners of the driving belt 571. The head unit 520 receives power from the driving belt 571 and rotates clockwise around the thermo-sensitive recording medium 200. At least one of the guide rollers 577 can be a driving roller operated by a driving motor 555 and the rest of the rollers can be idle rollers that rotate on their own axes as the driving roller operates.

The rotating thermal head 523 and magnetic head 525 record predetermined image information while scanning the thermo-sensitive recording medium 200. The heads 523 and 525 thermally or magnetically contact the upper surface and the lower surface of the thermo-sensitive recording medium. That is, the thermo-sensitive recording medium 200 is moved in one direction on the delivery path 560 by the transfer rollers 515 and 545. At this point, the head unit 520 mounted on the driving belt 571 thermally or magnetically contacts the thermo-sensitive recording medium 200 while rotating around the thermo-sensitive recording medium 200 that is being transferred with a constant speed. In more detail, the thermal head 523 scans the lower surface of the thermo-sensitive recording medium 200 and supplies thermal energy appropriate for the characteristic of the respective thermo-sensitive recording layers to sequentially develop the second thermo-sensitive recording layer and the first thermo-sensitive recording layer. Subsequently, both the thermal head 523 and the magnetic head 525 are operated to perform magnetic recording while scanning the upper surface of the thermo-sensitive recording medium 200. The head unit 520 can be rotated while being guided by guides 575. A controller 550 applies a control signal to a driving motor 555 and the head unit 520.

In this exemplary embodiment, the heads 523 and 525 themselves perform a scanning motion with respect to the thermo-sensitive recording medium 200. Therefore, unlike the device of FIG. 9, two thermal heads that face different surfaces of the thermo-sensitive recording medium 200 are not required to supply thermal energy to the different surfaces of the thermo-sensitive recording medium 200. That is, only one thermal head is required and is rotated around the thermo-sensitive recording medium, so that the thermo-sensitive recording can be performed on both sides of the thermo-sensitive recording medium.

As described above, according to the above-described thermo-sensitive recording medium, the thermo-sensitive recording device, and the thermo-sensitive recording method for the same, development conditions for at least three colors that should be developed so as to produce a full-color image are set independently, so that clear colors and definite edges can be maintained to produce a high quality multi-color image. Furthermore, the inventive recording device is simplified while improving image quality in comparison with the related art, so that printing costs can be reduced.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A thermo-sensitive recording medium comprising:
a thermo-sensitive magnetic recording layer having a matrix resin that becomes fluid when heated to a temperature higher than a first development temperature, which is a transition temperature, the thermo-sensitive magnetic recording layer having magnetic particles dispersed in the matrix resin whose outer surfaces are colored with a first color;
a first thermo-sensitive recording layer heated to a second development temperature to produce a second color;
a second thermo-sensitive recording layer heated to a third development temperature to produce a third color; and
a support layer supporting the thermo-sensitive magnetic recording layer, the first thermo-sensitive recording layer, and the second thermo-sensitive recording layer, wherein the first color, the second color, and the third color are developed independently and combined with one another to produce a multi-color image.

2. The thermo-sensitive recording medium of claim 1, wherein
the second development temperature is higher than the first development temperature.

3. The thermo-sensitive recording medium of claim 2, wherein
the third development temperature is higher than the second development temperature.

4. The thermo-sensitive recording medium of claim 1, wherein
the first color is cyan,
the second color is magenta, and
the third color is yellow.

5. The thermo-sensitive recording medium of claim 1, wherein
the matrix resin has an upper surface and a lower surface, and the magnetic particles are concentrated on the surface which is opposite to a display direction.

6. The thermo-sensitive recording medium of claim 1, wherein
the matrix resin comprises a polymer resin which is opaque with respect to light.

7. The thermo-sensitive recording medium of claim 1, wherein
the first thermo-sensitive recording layer is disposed at an inner side of the medium and the second thermo-sensitive recording layer is disposed at an outer side of the medium.

8. The thermo-sensitive recording medium of claim 1, further comprising:
an intermediate blocking layer interposed between the first thermo-sensitive recording layer and the second thermo-sensitive recording layer.

9. A thermo-sensitive recording medium on which a multi-color image which is visible from an upper direction is produced by thermo-sensitive recording and magnetic recording that are performed independently, the recording medium comprising:
a support layer;
a thermo-sensitive magnetic recording layer formed on the support layer and having a matrix resin that becomes fluid when heated to a temperature higher than a first development temperature, which is a transition temperature, the thermo-sensitive magnetic recording layer having magnetic particles whose outer surfaces are colored with a first color substantially uniformly dispersed in a lower side of the matrix resin;
a first thermo-sensitive recording layer formed on the thermo-sensitive magnetic recording layer and heated to a second development temperature to produce a second color; and
a second thermo-sensitive recording layer formed on the first thermo-sensitive recording layer and heated to a third development temperature to produce a third color.

10. The thermo-sensitive recording medium of claim 9, wherein
the second development temperature is higher than the first development temperature.

11. The thermo-sensitive recording medium of claim 10, wherein
the third development temperature is higher than the second development temperature.

12. A thermo-sensitive recording medium on which a multi-color image which is visible from an upper direction is produced by thermo-sensitive recording and magnetic recording that are performed independently, the recording medium comprising:
a support layer that is transparent with respect to light;
a thermo-sensitive magnetic recording layer formed on the support layer and having a matrix resin that becomes fluid when heated to a temperature higher than a first development temperature, which is a transition temperature, the thermo-sensitive magnetic recording layer having magnetic particles whose outer surfaces are colored with a first color substantially uniformly dispersed in a upper side of the matrix resin;
a first thermo-sensitive recording layer formed under the support layer and heated to a second development temperature to produce a second color; and
a second thermo-sensitive recording layer formed under the first thermo-sensitive recording layer and heated to a third development temperature to produce a third color.

13. The thermo-sensitive recording medium of claim 12, wherein
the second development temperature is higher than the first development temperature.

14. The thermo-sensitive recording medium of claim 13, wherein
the third development temperature is higher than the second development temperature.

15. A thermo-sensitive recording device for forming multi-color images on a thermo-sensitive recording medium having a-thermo-sensitive magnetic recording layer with a matrix resin with embedded magnetic particles, a first thermo-sensitive recording layer, and a second thermo-sensitive recording layer, the recording device comprising:
at least one thermal head supplying thermal energy to perform image-forming while scanning at least closely positioned with respect to the thermo-sensitive recording medium; and
a magnetic head operating simultaneously with the at least one thermal head and supplying magnetic force to perform image-forming while scanning at least closely positioned with respect to the thermo-sensitive recording medium.

16. The recording device of claim 15, wherein
the thermal-heads comprise heat-emitting resistors formed in parallel.

17. The recording device of claim 15, wherein
the magnetic head comprises magnetic poles formed in parallel.

18. A thermo-sensitive recording device for forming multi-color images on a thermo-sensitive recording medium having a thermo-sensitive magnetic recording layer with a matrix resin with embedded magnetic particles, a first thermo-sensitive recording layer, and a second thermo-sensitive recording layer, the recording device comprising:
a transfer means for transferring the thermo-sensitive recording medium back and forth along a delivery path;
a thermal head disposed at an upper portion of the delivery path and supplying thermal energy to perform image-forming while scanning at least closely positioned with respect to the thermo-sensitive recording medium delivered by the transfer means; and
a magnetic head disposed after the thermal head at an upper portion of the delivery path, operating simultaneously with the thermal head, and supplying magnetic force to perform image-forming while scanning at least closely positioned with respect to the thermo-sensitive recording medium.

19. The recording device of claim 18, wherein
the thermal head and the magnetic head operate simultaneously with respect to the thermo-sensitive magnetic recording layer to produce a first color,
the thermal head heats the first thermo-sensitive recording layer to a second development temperature to produce a second color, and
the thermal head heats the second thermo-sensitive recording layer to a third development temperature to produce a third color.

20. The recording device of claim 18, further comprising:
a cooling head disposed after the magnetic head at an upper portion of the delivery path, the cooling head forcibly cooling the thermo-sensitive magnetic recording layer after it has been developed by the magnetic head.

21. The recording device of claim 18, wherein
each of the thermal head and the magnetic head is elastically biased towards a pressure roller formed on an opposite side of the delivery path, and the thermo-sensitive recording medium is recorded while contacting the thermal head and the magnetic head.

22. A thermo-sensitive recording device for forming multi-color images on a thermo-sensitive recording medium having a thermo-sensitive magnetic recording layer with a matrix resin with embedded magnetic particles, a first thermo-sensitive recording layer, and a second thermo-sensitive recording layer, the recording device comprising:
a transfer means for transferring the thermo-sensitive recording medium back and forth along a delivery path;
a first thermal head disposed at a lower portion of the delivery path and supplying predetermined thermal energy to perform image-forming while scanning at least closely positioned with respect to the thermo-sensitive recording medium delivered by the transfer means;
a second thermal head disposed at an upper portion of the delivery path and supplying predetermined thermal energy to perform image-forming while scanning at least closely positioned with respect to the thermo-sensitive recording medium delivered by the transfer means; and
a magnetic head disposed after the second thermal head at a lower portion of the delivery path, operating simultaneously with the second thermal head, and supplying a predetermined magnetic force to perform image-forming while scanning at least closely positioned with respect to the thermo-sensitive recording medium.

23. The recording device of claim 22, wherein
the thermal head and the magnetic head operate simultaneously with respect to the thermo-sensitive magnetic recording layer to produce a first color,
the thermal head heats the first thermo-sensitive recording layer to a second development temperature to produce a second color, and
the thermal head heats the second thermo-sensitive recording layer to a third development temperature to produce a third color.

24. The recording device of claim 22, wherein
each of the thermal head and the magnetic head is elastically biased towards a pressure roller formed on an opposite side of the delivery path, and the thermo-sensitive recording medium is recorded while contacting the thermal head and the magnetic head.

25. A thermo-sensitive recording device for forming multi-color images on a thermo-sensitive recording medium having a thermo-sensitive magnetic recording layer with a matrix resin with embedded magnetic particles, a first thermo-sensitive recording layer, and a second thermo-sensitive recording layer, the recording device comprising:
a transfer means for transferring the thermo-sensitive recording medium in one direction along a delivery path; and
a head unit mounted on a driving belt rotating while enclosing the delivery path, the head unit having:
at least one thermal head supplying thermal energy to perform image-forming while scanning at least closely positioned with respect to the thermo-sensitive recording medium; and
a magnetic head mounted in parallel with the thermal head, operating simultaneously with the thermal head, and supplying magnetic force to perform image-forming while scanning at least closely positioned with respect to the thermo-sensitive recording medium.

26. A thermo-sensitive recording method for producing multi-color visual information using a thermo-sensitive recording medium having a first thermo-sensitive recording layer, a second thermo-sensitive recording layer, and a thermo-sensitive magnetic recording layer that have independent development conditions, respectively, the method comprising:
heating the first thermo-sensitive recording layer to a-first development temperature to produce a first color;
heating the second thermo-sensitive recording layer to a second development temperature to produce a second color; and
heating the thermo-sensitive magnetic recording layer to a third development temperature, which is a transition temperature, to change a matrix resin included in the thermo-sensitive magnetic recording layer to a fluid state, and providing magnetic force to force colored magnetic particles contained in the matrix resin to a display direction of an image, thereby producing a third color.

27. The method of claim 26, further comprising the step of:
after heating the thermo-sensitive magnetic recording layer, cooling the thermo-sensitive magnetic recording layer to a temperature lower than the transition temperature to fix a display position of the magnetic particles.
